(19) United States
(12) Patent Application Publication
(10) Pub. No.: US 2013/0070727 A1
(43) Pub. Date: Mar. 21, 2013

(54) MECHANISM TO IMPROVE HANDOVER SPEED IN SMALL CELLS

(71) Applicants: Michael Dolan, Bolingbrook, IL (US); Zhibi Wang, Woodridge, IL (US)

(72) Inventors: Michael Dolan, Bolingbrook, IL (US); Zhibi Wang, Woodridge, IL (US)

(73) Assignee: ALCATEL-LUCENT USA INC., Murray Hill, NJ (US)

(21) Appl. No.: 13/236,116

(22) Filed: Sep. 19, 2011

(51) Int. Cl. H04W 36/00

(52) U.S. Cl. 370/331

(57) ABSTRACT

In a method for performing handover of a user equipment, a small cell base station formats a handover request message for the user equipment. The handover request message includes permission information of the user equipment, including LIPA permission information.

### BACKGROUND OF THE INVENTION

A small cell, such as a femto cell, typically covers a smaller geographic area or subscriber constituency than a conventional macro cell. In one example, a small cell typically provides radio coverage in a geographical area such as a building or home. By contrast, a conventional macro cell typically provides radio coverage in a larger area such as an entire city or town.

When a mobile device enters a small cell, a management system, for example a femto management system, informs the small cell whether the mobile device is to be granted certain permissions. In one example, the permissions may include permission to access the small cell. The mobile device may also be granted local IP access (LIPA) to IP-based services and devices on the Local Area Network (LAN) to which a small cell is connected.

Conventionally, when a mobile device moves from a first small cell to a second small cell, the context parameters necessary for radio connectivity are transferred from the first small cell to the second small cell. However, there is no conventional mechanism that transfers the various mobile device LIPA permissions together with the context parameters. Therefore, the second small cell cannot complete all aspects of the handover until the second small cell has been notified of all the various permissions needed by the mobile device to operate successfully in the second small cell.

For the second small cell to obtain notification of the mobile device permissions that are not transferred from the first small cell may take a non-negligible amount of time. If the time delay is larger than the time before the mobile device loses the radio coverage of the first small cell, the mobile device user may experience various problems. If the mobile device is handed over from the first small cell to the second small cell without the full set of permissions, such as LIPA permissions, reconnection to existing services may be delayed for a non-negligible amount of time, leading to other various problems for the mobile user. These problems may include, for example, dropped calls and sub-optimal access to networked devices in the LAN. Some services may be discontinued and need to be re-established. For example, LIPA may need to be restarted because the second small cell is not aware of the IP address associated with the mobile device, and is unwilling to trust the mobile device to provide the IP address. The mobile device requires this IP address in order to access the LAN associated with the first and second small cells.

Moreover, there is no conventional mechanism for securely making available all the permission information, including but not limited to LIPA permission information, at the time of the handover request to the second small cell. In current wireless standards, a mobile device may send its IP address to a small cell when it enters the coverage area of the small cell. However, this introduces potential security problems because the mobile device may not be a device that can be trusted by the small cell.

### SUMMARY OF THE INVENTION

At least some example embodiments provide methods for performing handover of mobile devices in a small cell network such that permission information, including at least local IP access (LIPA) permission information, is transferred at the time of the handover. Example embodiments may configure a handover message from a first small cell to a second small cell, and receive handover messages at a second small cell. At least other example embodiments provide systems for performing handover of a user equipment in a small cell system, the systems including small cell base stations for configuring and receiving handover messages including permission information, including at least local IP access (LIPA) permission information, of a user equipment.

At least one example embodiment provides a method for performing handover of a user equipment. According to at least this example embodiment, the method includes formatting, at a small cell base station, a handover request message for the user equipment. The handover request message includes permission information, including at least local IP access (LIPA) permission information, of the user equipment.

At least one other example embodiment provides a method for accepting a handover of a user equipment. According to at least this example embodiment, the method includes receiving, at a small cell base station, a handover request message including permission information, including at least local IP access (LIPA) permission information, of the user equipment, and determining that the user equipment can be supported by the small cell base station. The permission information of the user equipment is saved in a user equipment context.

At least one other example embodiment provides a system for performing handover of a user equipment. According to at least this example embodiment, the system includes a small cell base station configured to format a handover request message. The handover request message includes permission information, including at least local IP access (LIPA) permission information, of the user equipment.

At least one other example embodiment provides a system for performing handover of a user equipment. According to at least this example embodiment, the system includes a small cell base station configured to receive a handover request message including permission information, including at least local IP access (LIPA) permission information, of a user equipment, and to determine whether the user equipment can be supported. The small cell base station is configured to save the permission information of the user equipment in a user equipment context.

### BRIEF DESCRIPTION OF THE DRAWINGS

The present invention will become more fully understood from the detailed description given herein below and the accompanying drawings, where like elements are represented by like reference numerals, which are given by way of illustration only and thus are not limiting of the present invention and wherein:

FIG. 1 illustrates a portion of a radio access network (RAN);

FIG. 2 illustrates a flowchart and communications diagram illustrating an example embodiment of a method for performing a handover in a small cell network;

FIG. 3 illustrates a conventional handover request message; and

FIG. 4 illustrates a handover request message according to an example embodiment.

### DETAILED DESCRIPTION OF THE EMBODIMENTS

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. This invention may, however, may be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements (e.g., small cells, small wireless access points, femto access points, etc.). Such existing hardware may include one or more Central Processing Units (CPUs), digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

Example embodiments may be utilized in conjunction with RANs such as: Universal Mobile Telecommunications System (UMTS); Global System for Mobile communications (GSM); Advance Mobile Phone Service (AMPS) system; the Narrowband AMPS system (NAMPS); the Total Access Communications System (TACS); the Personal Digital Cellular (PDC) system; the United States Digital Cellular (USDC) system; the code division multiple access (CDMA) system described in EIA/TIA IS-95; a High Rate Packet Data (HRPD) system, Worldwide Interoperability for Microwave Access (WiMAX); ultra mobile broadband (UMB); and 3^{rd} Generation Partnership Project Long Term Evolution (3GPP LTE).

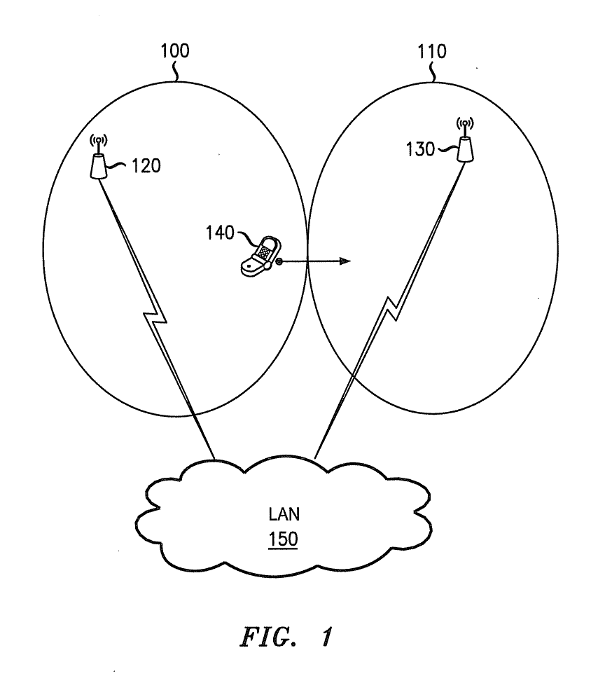

FIG. 1 illustrates a portion of a radio access network (RAN) in which example embodiments may be implemented.

Referring to FIG. 1, the RAN includes at least a first small cell 120 and a second small cell 130 that provide radio frequency (RF) coverage within a relatively small geographical area 100, 110 respectively. As used herein, the phrase “small cell” may refer to any relatively small cell or access point, such as a femto cell, femto access point (or base station), pico cell, pico access point (or base station), micro cell, micro access point (or base station), metro cell, metro access point (or base station) nano cell, nano access point (or base station), etc.

As discussed herein, a local network refers to a home, office, or campus-based local area network (LAN) or other computer network that connects computers and/or other devices in a relatively limited geographical area such as a home, school, computer laboratory, office, etc. By contrast, as discussed herein, a wireless telecommunications network, wireless network or mobile network refers to one or more radio access networks including macro and/or small cells providing radio access to users over a larger geographical area.

The small cells 120, 130 are connected to a LAN 150. The LAN 150 may include locally connected devices and services. The locally connected devices and services may include printers, computers, set-top boxes, Internet-enabled televisions, security systems, home appliances, HVAC systems, other small wireless access points, etc.

Referring still to FIG. 1, in an example embodiment, a user equipment (UE) 140 is located within the coverage area 100 of the small cell 120. If the user equipment 140 is granted/permitted local Internet Protocol (IP) access (LIPA) to the small cell 120, the user equipment 140 is able to access the LAN 150 as well as the operator's core network and the Internet directly through the air interface of the small cell 120. According to at least some example embodiments, access to the LAN 150 includes access to IP-based devices and/or services on the LAN 150.

Permission to access the wireless network directly through the air interface of the small cell 120 is determined according to the rules of the specific air interface. For example, permission to access the wireless network directly through the air interface of the small cell 120 may be determined according to UMTS standards, HRPD standards, etc., using identifiers, procedures, and authentication and authorization mechanisms defined for that particular air interface. Because methods for obtaining such permission are known in the art, a detailed discussion is omitted.

The UE 140 is a UE such as mobile telephones, portable computers, pocket computers, hand-held computers, personal digital assistants (PDAs), car-mounted mobile devices, other IP-enabled devices, or the like, which communicate voice and/or data with the RAN. Throughout this disclosure, the term “users,” “user equipments,” “UEs,” “mobiles,” “mobile stations,” etc. may be used interchangeably.

Referring still to FIG. 1, the RAN includes at least a second small cell 130. For example purposes, FIG. 1 shows only a first small cell 120, a second small cell 130 and one UE 140. However, it will be understood that RANs may include any number of access point management systems and/or small cells, which serve any number of users.

As is shown, a UE 140 may move out of the coverage area 100 of a first small cell 120 into the coverage area 110 of a second small cell 130. When a UE 140 moves out of the coverage area 100 of a first small cell 120, a handover must be performed in order that the UE 140 may still receive RAN services. The handover includes at least LIPA permission information in order that the second small cell 130 can seamlessly resume services to the UE 140.

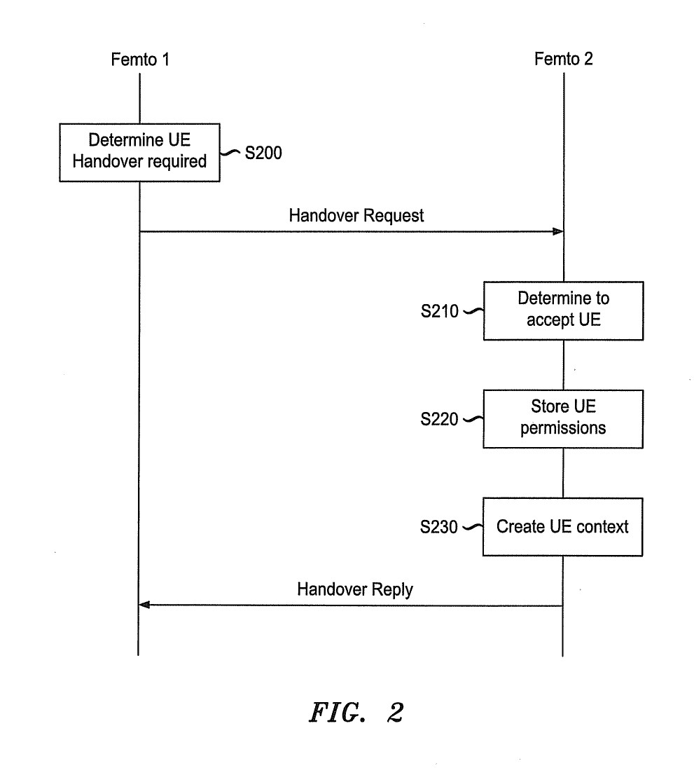

FIG. 2 is a flowchart and communication diagram illustrating an example embodiment of a method for performing a handover of a UE 140 from a first small cell 120 of a RAN to a second small cell 130 of the RAN. The method includes steps to be performed by the first small cell 120 as well as steps to be performed by the second small cell 130. The method includes messages to be passed between the first small cell 120 and the second small cell 130. It should be understood that the steps may be performed by either of the first small cell 120 or the second small cell 130 depending on the geographical area 100, 110 of the UE 140 before the handover occurred. Moreover, it should be understood that a UE 140 may pass from the second small cell 130 to the first small cell 120 or to any other small cells in the RAN, not shown.

Referring to FIG. 2, at step S200, the first small cell 120 has determined that the UE 140 has moved from the geographical region 100 served by the first small cell 120 to the geographical region 110 served by the second small cell 130. Upon making this determination 5200, the first small cell 120 sends a handoff request message to the second small cell 130. The handoff request message contains radio parameters for providing service to the UE 140 at second small cell 130. The handoff request message further contains information about the permissions and authorizations related to the UE 140 that have been provided to the UE 140. Referring again to FIG. 2, at step S210, the second small cell 130 determines whether it can support the UE 140. The second small cell 130 determines this by examining the parameters sent to the second small cell 130. These parameters may indicate different services required by the UE 140 and the second small cell 130 must decide whether it is able to support these services. For example, the determination may involve knowing whether the particular radio functions in use on the first small cell 120 can be continued on the second small cell 130, whether there are sufficient resources at the second small cell 130 to support the ongoing services required by the UE 140, and, in particular, whether the second small cell 130 can support LIPA.

At step S220, the permission information related to the UE 140 is noted and stored within the storage capability, for example, the memory, of the second small cell 130. At step S230, a context is created for the UE 140. The second small cell 130 then sends a handover reply message to the first small cell 120 that signifies that the handover is accepted. If the second small cell 130 determines that it is not possible to accept the handover of the UE 140, the second small cell 130 sends a handover reject message (not shown) according to the rules and procedures of the particular radio interface. Upon receiving the handover reply message from the second small cell 130, the first small cell 120 completes handover of the UE 140, and communications and services are thereafter provided to the UE 140 through the second small cell 130.

It should be appreciated that the handover request message may be passed through and modified by intervening equipment in example embodiments. However, concepts of the handover request message will remain the same because permission information, including at least LIPA permission information, is nevertheless included in the handover message.

For example, in a 1× network, the first small cell 120 may send a Handoff Required message to a Mobile Switching Center (MSC). The MSC may convert the Handoff Required message to a Handoff Request message and forward this Handoff Request message to the second small cell 130. The second small cell 130, in an example embodiment, may reply with a Handoff Request Acknowledge to be converted by the MSC into a Handoff Command, which is in turn received by the first small cell 120. It should further be appreciated that other radio technologies may similarly use messages with different names and parameters, and these messages may pass through additional entities.

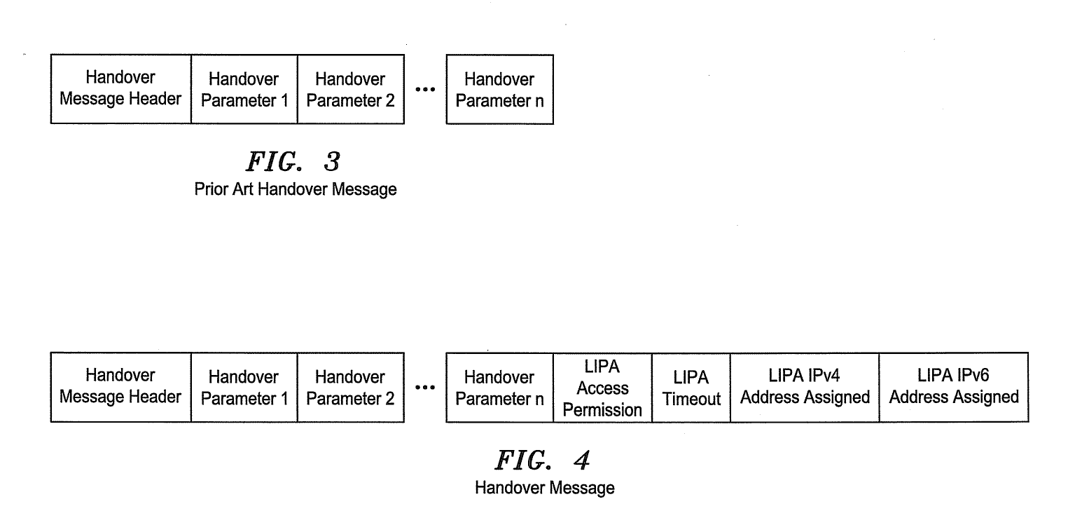

A conventional handover request message is depicted in FIG. 3. A conventional handover request message may include any number of handover parameters. Handover parameters may include user identity information, encryption keys, session state information, sector identifiers, etc. Handover parameters may vary with the communication standard in use in a given system.

An example handover request message according to an example embodiment is depicted in FIG. 4. In an example embodiment, the handover request message includes context information. The handover request message additionally includes LIPA permission information and any IP addresses that had been allocated to the UE 140. In accordance with at least one example embodiment, the LIPA permission information may be in the form of at least two fields. The two fields are referred to herein as the “LIPA Access Permission” field and the “LIPA Timeout” field. Further in accordance with an example embodiment, the IP addresses may be in the form of two fields. The two IP address fields are referred to herein as the “LIPA IPv4 Address” and the “LIPA IPv6 Address.”

The LIPA Access Permission field includes local access control information indicating whether a particular user is permitted LIPA at a particular small cell or cells. The LIPA Access Permission information will allow the first small cell 120 to determine that it may provide LIPA service to the UE 140. Likewise, when the second small cell 130 receives the content of the LIPA Access Permission field in the handover request message, it will be able to determine whether it should provide LIPA service to the UE 140. The LIPA Timeout field includes time information indicative of a limit on the time a user's LIPA authorization is valid. The time information may be an absolute time or a delta/offset (change) from the time when LIPA is granted. For example, the time information may identify a date and time after which a user's LIPA to the small cell is no longer valid. Alternatively, the time information may include a finite period of time during which the user is authorized LIPA to the small cell after being granted LIPA.

The time information for a user may be infinite for a regular user, such as the owner of the small cell. In this case the user's LIPA to the local network may be permanent. Alternatively, the time information for a temporary user, such as a visitor, whose LIPA needs to be controlled may be set to expire after a given period of time or at a set date, time, etc. It should be appreciated that in some example embodiments, the absence of a LIPA Timeout field may indicate that no timeout should be applied to the access permission. That is, the access permission may be understood to be infinite and the LIPA access permission may not be revoked on the basis of time.

If the LIPA Access Permission field is on (e.g., the LIPA Access Permission is set to a given value) for a particular user at a particular small cell, then the user is granted LIPA rights within the LIPA Timeout time period at that particular small cell.

If the LIPA Access Permission and LIPA timeout fields are off, then the small cell 130 detei in ines that the UE 140 is not permitted LIPA to the LAN 150 via the small cell 130. The LIPA Access Permission field may be considered “off” when the field is set to a value other than the value indicating that the UE 140 is permitted to access the LAN 150. It should be understood that the actual field may be composed of one or more parts or subparts that contain one or more values that jointly provide authorization or non-authorization to access the LAN 150. The LIPA Timeout field may be considered “off” if the field is set to a time duration which has expired, or if the time for access occurs in the past.

The LIPA permission information may be provided to the first small cell 120 at initialization or boot-up of the small cell 120. Alternatively, the LIPA information may be provided to the small cell 120 when the UE 140 receives permission to access the wireless network directly through the air interface of the small cell 120 when the UE 140 first enters the geographical area 100 of the small cell 120.

The LIPA IPv4 Address and LIPA IPv6 Address are Internet Protocol (IP) addresses. An IP address is a numerical label assigned to devices in a computer network that uses the Internet Protocol for communication. Two versions of the Internet Protocol are in use and they each define IP addresses differently. The LIPA IPv4 Address corresponds to a 32-bit number used in the addressing scheme of IPv4. The LIPA IPv6 Address corresponds to the IPV6 addressing system that uses 128-bit numbers. The particular structure used in each of these addressing systems is well-known in the art and will not be described herein. It should be anticipated that further versions of an IP addressing system will be required and that example embodiments will encompass any future IP addressing systems.

In at least one example embodiment, IP addresses may be assigned dynamically when the system of FIG. 1 is first powered on. Additionally, IP addresses may be assigned statically by fixed configuration of the hardware or software of the system of FIG. 1. Methods of IP address assignment are well-known in the art and will not further be described herein.

As discussed previously, a UE 140 is likely aware of its IP address at the time of handover from the first small cell 120 to the second small cell 130 and is therefore capable of informing the second small cell 130 of its IP address upon handover. Conventionally, the UE 140 may pass the IP address itself upon handover in order to speed up the process of handover. However, if this IP address is handed over by the UE 140, instead of by the first small cell 120, security may be broken because the UE 140 is not trusted by the second small cell 130.

On the other hand, the first small cell 120 is another trusted femto cell on the same LAN 150 as the second small cell. Therefore, when the first small cell 120 passes the IP address in the LIPA IPv4 Address or the LIPA IPv6 Address fields of the handover request message, security is maintained.

Nevertheless, any IP address passed by the UE 140 may still be used by the second small cell 130. In at least one example embodiment, the second small cell 130 compares either the LIPA IPv4 Address or the LIPA IPv6 Address received from the first small cell 120 to the address received from the UE 140. If these do not match, the second small cell 130 may deny the UE 140 access to the LAN 150 on the grounds that the UE 140 may have obtained a fraudulent IP address.

The invention being thus described, it will be obvious that the same may be varied in many ways. Such variations are not to be regarded as a departure from the invention, and all such modifications are intended to be included within the scope of the invention.

We claim:

1. A method for performing a handover of a user equipment, comprising:
formatting, at a small cell base station, a handover request message for the user equipment, the handover request message including permission information of the user equipment, the permission information including at least local IP access (LIPA) permission information.

2. The method of claim 1 wherein the permission information includes user equipment permissions pertaining to a Local Area Network (LAN).

3. The method of claim 2 wherein the LIPA permission information includes access permission, an IP address, and a timeout value indicating when the access permission is no longer valid in the LAN.

4. The method of claim 3, wherein the IP address information includes at least one of IPv4 and IPv6 address information.

5. The method of claim 1, wherein the handover request message further includes context information including radio parameter fields required to provide service to the user equipment.

6. The method of claim 5, wherein the context information includes user identity information, an encryption key, session state information, and a sector identifier.

7. A method for accepting a handover of a user equipment, comprising:
receiving, at a small cell base station, a handover request message including permission information of the user equipment, the permission information including at least local LP access (LIPA) permission information;
determining that the user equipment can be supported by the small cell base station; and
saving the permission information of the user equipment in a user equipment context.

8. The method of claim 7 wherein the user equipment context further includes the identity of the user equipment, an encryption key, session state information, and a sector identifier.

9. The method of claim 7 wherein the permission information includes an IP address of the user equipment.

10. The method of claim 8, wherein the IP address is provided by a second small cell base station, the small cell base station and the second small cell base station having access to the same Local Area Network (LAN).

11. The method of claim 10, further comprising:
verifying the IP address against an IP address provided by the user equipment on handover; and
declining access to the LAN if the IP address provided by the second small cell base station does not match the IP address provided by the user equipment on handover.

12. A system for performing handover of a user equipment, comprising:
a small cell base station configured to format a handover request message, the handover request message including permission information of the user equipment, the permission information including at least local IP access (LIPA) permission information.

13. The system of claim 12, wherein the permission information includes user permissions pertaining to a Local Area Network (LAN).

14. The system of claim 13, wherein the LIPA permission information includes access permission, an IP address, and a timeout value indicating when the access permission is no longer valid in the LAN.

15. The system of claim 14, wherein the IP address information includes at least one of IPv4 and IPv6 address information.

16. The system of claim 12, wherein the handover request message further includes context information including radio parameter fields required to provide service to the user equipment.

17. The system of claim 16, wherein the context information includes user identity information, an encryption key, session state information, and a sector identifier.

18. A system for performing handover of a user equipment, the system comprising a small cell base station configured to:
receive a handover request message including permission information of user equipment, the permission information include at least local IP access (LIPA) permission information;
determine whether the user equipment can be supported; and
save the permission information of the user equipment in a user equipment context.

19. The system of claim 18, wherein the permission information includes the IP address of the user equipment.

20. The system of claim 18, wherein the user equipment context includes identity of the user equipment, an encryption key, session state information, and a sector identifier.
